(19) United States
(12) Patent Application Publication
(10) Pub. No.: US 2025/0284612 A1
(43) Pub. Date: Sep. 11, 2025

(54) ARTIFICIAL INTELLIGENCE GOVERNED PROCESSOR

(71) Applicant: International Business Machines Corporation, Armonk, NY (US)

(72) Inventors: David Trilla Rodríguez, New York, NY (US); Alper Buyuktosunoglu, White Plains, NY (US)

(21) Appl. No.: 18/596,799

(22) Filed: Mar. 6, 2024

(51) Int. Cl. G06F 11/34; G06N 20/00

(52) U.S. Cl. CPC G06F 11/3409; G06N 20/00

(57) ABSTRACT

A method includes identifying tasks to be completed by an AI governed processing unit, monitoring performance metrics of the AI governed processing unit, training an AI governance engine to predict performance corresponding to the AI governed processing unit based on the monitored performance metrics and workload features corresponding to the identified tasks, determining whether a predicted performance metric according to the AI governance engine exceeds the monitored one or more performance metrics, and responsive to determining the predicted performance metric exceeds the monitored performance metrics, enabling the AI governance engine to optimize workload allocation relative to the identified tasks and the AI governed processing unit. A system includes an artificial intelligence (AI) governance engine, an AI governed processing pipeline configured to execute a set of tasks, and one or more performance monitors configured to monitor performance of the AI governed processing pipeline.

### BACKGROUND OF THE INVENTION

The present invention relates generally to the field of processor architecture, and more specifically to increasing performance and efficiency in processors using machine learning techniques.

Typically, processors are implemented as pipeline architectures where instructions flow at each cycle using the available computational resources. Pipelined processors can be subject to structural hazards, wherein the resources must be free to be used when they are needed. Pipelined processor performance can additionally be impacted by data hazards; in other words, data must be available to be read or written for pipelined processors to proceed appropriately. Further, pipelined processors are subject to control hazards, such that the correct instructions must be fetched and ready to be executed at any given time to carry out execution. A considerable amount of design effort, power, and die area is focused towards minimizing the impact of these hazards. Such capabilities come at the cost of more area and energy invested in control structures rather than compute structures. Further, designers are required to include large amounts of on-chip memory to facilitate these efforts.

Advances in machine learning (ML) and artificial intelligence (AI) provide higher degrees of predictive capability that can be leveraged by microarchitectures to increase performance and energy efficiency. Machine learning/artificial intelligence models are effective for predicting dynamic temporal patterns (such as address sequences, for example). Current core and processor designs utilize a considerable amount of area (up to 50-60% in some cases) to control and data structures. The decisions made by such control structures, such as prioritization decisions, do not always adjust the workload, may in some cases be suboptimal, and can be subject to human biases and any existing deficiencies of “average” cases. In general, there doesn't exist a good hold for what data might be needed in the future, thus leaving performance on the table and wasting area.

Machine learning and artificial intelligence solutions are posed to solve classical computer architecture predictive problems such as prefetching, branch prediction, scheduling, and the like. At current, however, no implementations in the art exist which leverage an AI-governed processor. Creation of such an AI-governed processor is an opportunity to create a unified control inference engine capable of understanding workload definition and acting accordingly to save area and power while also increasing performance.

### SUMMARY

Embodiments of the present invention disclose a computer-implemented method comprising identifying a set of tasks to be completed by an AI governed processing unit, monitoring performance metrics corresponding to the AI governed processing unit's performance while working on the set of tasks, training an AI governance engine to predict performance corresponding to the AI governed processing unit based on the monitored performance metrics and workload features corresponding to the identified set of tasks, determining whether a predicted performance metric according to the AI governance engine exceeds the monitored one or more performance metrics, and responsive to determining the predicted performance metric exceeds the monitored one or more performance metrics, enabling the AI governance engine to optimize workload allocation relative to the identified set of tasks and the AI governed processing unit. AI governance of a processing pipeline in this manner provides increased performance while also increasing efficiency in technical requirements.

In embodiments, enabling the AI governance engine to optimize workload allocation includes activating a setting corresponding to the AI governance engine such that said setting is in an “ON” position. Allowing the AI governance engine to be toggled to “ON” enables selective implementation of the AI governance engine, thus requiring the associated resources be utilized only when necessary.

In embodiments, enabling the AI governance engine to optimize workload allocation includes allocating tasks separately to different units of the AI governed processing unit. Allocating tasks separately in this manner allows tasks to be allocated to a unit of the AI governed processing unit best suited to carry out said task.

In embodiments, enabling the AI governance engine to optimize workload allocation includes enabling the AI governance engine for a subset of the set of tasks. Enabling the AI governance engine for a subset of the set of tasks increases the efficiency of the AI governance engine and overall execution by limiting the queue of tasks to be analyzed and managed via the AI governance engine while still reaping the benefits of increased efficiency and performance relative to the tasks managed by the AI governance engine.

In embodiments, enabling the AI governance engine to optimize workload allocation includes denying the AI governance engine access to a specified subset of the set of tasks. Denying the AI governance engine access to a specified subset of tasks allows selective exclusion of certain tasks, such as those where a client prefers private data not be exposed to the AI governance engine, etc.

Embodiments of the present invention disclose a computer program product comprising computer readable storage media storing instructions for identifying a set of tasks to be completed by an AI governed processing unit, monitoring performance metrics corresponding to the AI governed processing unit's performance while working on the set of tasks, training an AI governance engine to predict performance corresponding to the AI governed processing unit based on the monitored performance metrics and workload features corresponding to the identified set of tasks, determining whether a predicted performance metric according to the AI governance engine exceeds the monitored one or more performance metrics, and responsive to determining the predicted performance metric exceeds the monitored one or more performance metrics, enabling the AI governance engine to optimize workload allocation relative to the identified set of tasks and the AI governed processing unit. AI governance of a processing pipeline in this manner provides increased performance while also increasing efficiency in technical requirements.

In embodiments, program instructions for enabling the AI governance engine to optimize workload allocation include activating a setting corresponding to the AI governance engine such that said setting is in an “ON” position. Allowing the AI governance engine to be toggled to “ON” enables selective implementation of the AI governance engine, thus requiring the associated resources be utilized only when necessary.

In embodiments, program instructions for enabling the AI governance engine to optimize workload allocation include allocating tasks separately to different units of the AI governed processing unit. Allocating tasks separately in this manner allows tasks to be allocated to a unit of the AI governed processing unit best suited to carry out said task.

In embodiments, program instructions for enabling the AI governance engine to optimize workload allocation include enabling the AI governance engine for a subset of the set of tasks. Enabling the AI governance engine for a subset of the set of tasks increases the efficiency of the AI governance engine and overall execution by limiting the queue of tasks to be analyzed and managed via the AI governance engine while still reaping the benefits of increased efficiency and performance relative to the tasks managed by the AI governance engine.

In embodiments, program instructions for enabling the AI governance engine to optimize workload allocation include denying the AI governance engine access to a specified subset of the set of tasks. Denying the AI governance engine access to a specified subset of tasks allows selective exclusion of certain tasks, such as those where a client prefers private data not be exposed to the AI governance engine, etc.

Embodiments of the present invention disclose a computer program system comprising one or more computer processors and one or more computer readable storage media storing instructions for identifying a set of tasks to be completed by an AI governed processing unit, monitoring performance metrics corresponding to the AI governed processing unit's performance while working on the set of tasks, training an AI governance engine to predict performance corresponding to the AI governed processing unit based on the monitored performance metrics and workload features corresponding to the identified set of tasks, determining whether a predicted performance metric according to the AI governance engine exceeds the monitored one or more performance metrics, and responsive to determining the predicted performance metric exceeds the monitored one or more performance metrics, enabling the AI governance engine to optimize workload allocation relative to the identified set of tasks and the AI governed processing unit. AI governance of a processing pipeline in this manner provides increased performance while also increasing efficiency in technical requirements.

In embodiments, program instructions for enabling the AI governance engine to optimize workload allocation include activating a setting corresponding to the AI governance engine such that said setting is in an “ON” position. Allowing the AI governance engine to be toggled to “ON” enables selective implementation of the AI governance engine, thus requiring the associated resources be utilized only when necessary.

In embodiments, program instructions for enabling the AI governance engine to optimize workload allocation include allocating tasks separately to different units of the AI governed processing unit. Allocating tasks separately in this manner allows tasks to be allocated to a unit of the AI governed processing unit best suited to carry out said task.

In embodiments, program instructions for enabling the AI governance engine to optimize workload allocation include enabling the AI governance engine for a subset of the set of tasks. Enabling the AI governance engine for a subset of the set of tasks increases the efficiency of the AI governance engine and overall execution by limiting the queue of tasks to be analyzed and managed via the AI governance engine while still reaping the benefits of increased efficiency and performance relative to the tasks managed by the AI governance engine.

In embodiments, program instructions for enabling the AI governance engine to optimize workload allocation include denying the AI governance engine access to a specified subset of the set of tasks. Denying the AI governance engine access to a specified subset of tasks allows selective exclusion of certain tasks, such as those where a client prefers private data not be exposed to the AI governance engine, etc. An AI governed processing pipeline provides increased performance while also increasing efficiency in technical requirements.

Embodiments of the present invention disclose a system comprising an artificial intelligence (AI) governance engine, an AI governed processing pipeline configured to execute a set of one or more processing tasks, and one or more performance monitors configured to monitor performance of the AI governed processing pipeline. AI governance of a processing pipeline in this manner provides increased performance while also increasing efficiency in technical requirements.

In embodiments, the system further includes a sanity check unit configured to determine whether outputs of the AI governed processing pipeline adhere to one or more expected protocols. Utilizing a sanity check unit of this nature allows confirmation that the outputs of the AI governed processing pipeline make sense.

In embodiments, the system further includes a training module configured to process performance metrics as provided by the performance monitors and train the AI governance engine to infer performance outcomes based on the performance metrics as provided by the performance monitors and one or more features of the set of one or more processing tasks. Incorporating a training module of this nature enables informed inference of performance outcomes.

In embodiments, the AI governance engine is configured to predict a set of memory data which will be helpful for analyzing performance of the AI governed processing pipeline. Predicting a set of useful memory data enables increased efficiency when fetching such data.

In embodiments, the system further includes one or more memory buffers configured to store the predicted set of memory data. Incorporating memory buffers of this nature increases efficiency of the data fetch by ensuring useful memory data is stored in a consistent location.

Embodiments of the present invention disclose a method comprising receiving one or more performance metrics corresponding to an artificial intelligence governed processing pipeline, training an artificial intelligence governance engine to predict performance outcomes based on performance metrics, and determining an optimal resource allocation relative to a selected workload based on the trained AI governance engine. AI governance of a processing pipeline in this manner provides increased performance while also increasing efficiency in technical requirements.

In embodiments, the method further includes determining whether the predicted performance outcomes of the AI governed processing pipeline adhere to one or more expected protocols. Utilizing a sanity check of this nature allows confirmation that the outputs of the AI governed processing pipeline make sense.

In embodiments, the method further includes processing performance metrics as provided by one or more performance monitors and training the AI governance engine to infer performance outcomes based on the performance metrics as provided by the performance monitors and one or more features of the selected workload. Incorporating a training module of this nature enables informed inference of performance outcomes.

In embodiments, the AI governance engine is configured to predict a set of memory data which will be helpful for analyzing performance of the AI governed processing pipeline. Predicting a set of useful memory data enables increased efficiency when fetching such data.

In embodiments, the method further includes fetching and storing the predicted set of memory data. Storing the predicted set of memory data in this manner increases efficiency of the data fetch by ensuring useful memory data is stored in a consistent location.

### BRIEF DESCRIPTION OF THE DRAWINGS

FIG. 1 is a functional block diagram depicting an AI-governance pipeline in accordance with at least one embodiment of the present invention;

FIG. 2 is a functional block diagram depicting a dispatching environment in accordance with at least one embodiment of the present invention;

FIG. 3 is a flowchart depicting a dispatch method in accordance with at least one embodiment of the present invention;

FIG. 4 is a functional block diagram depicting a neural environment in accordance with at least one embodiment of the present invention; and

FIG. 5 illustrates an exemplary computer environment in which aspects of one or more of the illustrative embodiments may be implemented, and at least some of the computer code involved in performing the inventive methods may be executed, in accordance with an embodiment of the present invention.

### DETAILED DESCRIPTION

Embodiments as disclosed herein enable increases in AI engine accuracy which may allow increased use of AI for predictive computing. Embodiments as disclosed herein may enable unification of control structures; typically designed as separate instances, control and predictive structures are bundled together in a single engine that can learn and influence each other and thus unify decision making into a same structural unit. Embodiments as disclosed herein may increase area availability for compute units by unifying the decision and fetch engines and heuristics, thus increasing system performance. In general, embodiments as disclosed herein may enable an AI governance engine configured to control a processing pipeline such that the AI governance engine may manage, and thereby optimize, functionality of components of the processing pipeline relative to a running workload.

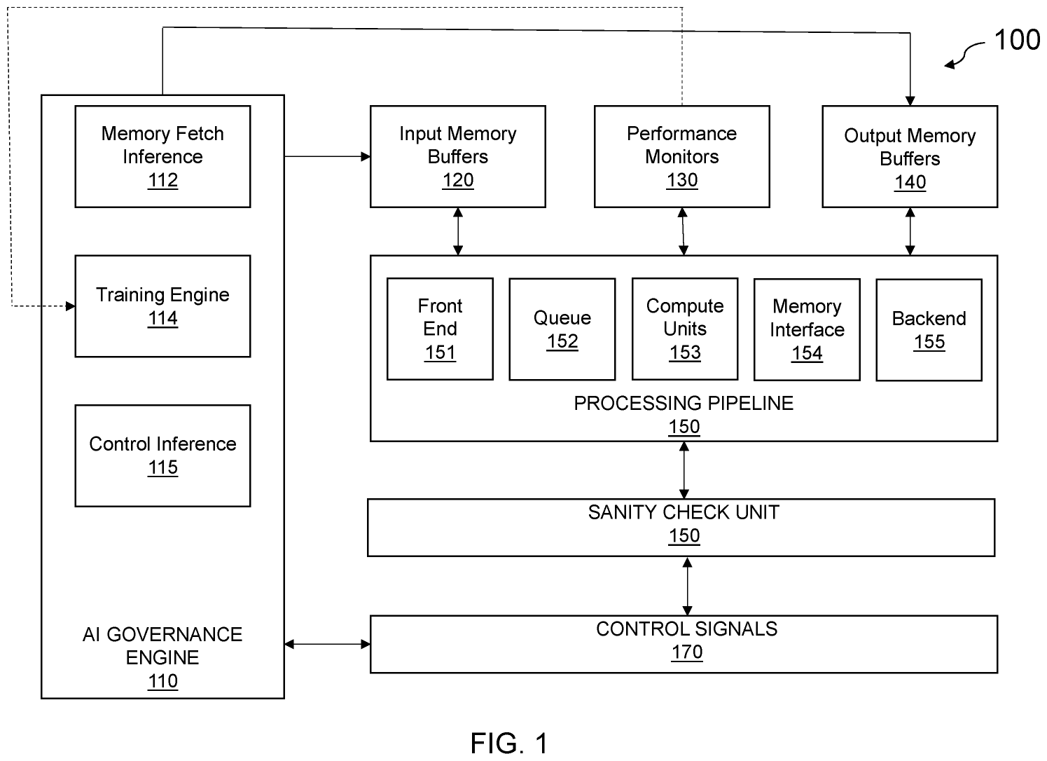

FIG. 1 is a functional block diagram depicting an AI-governance pipeline 100 in accordance with at least one embodiment of the present invention. As depicted, AI-governance pipeline 100 includes AI governance engine 110, input memory buffers 120, performance monitors 130, output memory buffers 140, processing pipeline 150, sanity check unit 160, and control signals 170. AI-governance pipeline 100 may enable unified control inference and increased performance while also increasing efficiency in power utilization and space requirements on a chip. In general, AI-governance pipeline 100 refers to a traditional pipelined processor, such as processing pipeline 150, interfaced with an AI-governance engine, such as AI governance engine 110. AI-governance pipeline 100 may enable an inference engine to control the datapath of the processor pipeline. In at least some embodiments, data and instructions are fetched under AI-governance demand.

The present invention may contain various accessible data sources that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. An interface of AI-governance pipeline 100 enables the authorized and secure processing of personal data. An interface of AI-governance pipeline 100 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. AI-governance pipeline 100 provides information regarding personal data and the nature (e.g., type, scope, purpose, duration, etc.) of the processing. AI-governance pipeline 100 provides the user with copies of stored personal data. AI-governance pipeline 100 allows the correction or completion of incorrect or incomplete personal data. AI-governance pipeline 100 allows the immediate deletion of personal data.

AI governance engine 110 includes a memory fetch inference unit 112, a training engine 114, and a control inference unit 115. In some embodiments, AI-governance engine 110 receives as inputs a processor status and additional detailed monitoring data including, but not limited to, performance metrics and address usage. With respect to memory fetch inference unit 112 and control inference unit 115, an epoch is defined for enabling a granularity of inference. In at least some embodiments, the epoch is defined according to time units. In other embodiments, the epoch is defined according to a processor metric such as executed instructions. At the end of a given epoch, AI governance engine 110 is configured to issue a set of directives to be followed/carried out during the following epoch. Memory fetch inference 112 may be configured to fetch and store observed control signals, performance monitors, processor performance, and workload types. In general, control and processor status signals flow to the AI governance engine 110.

Memory fetch inference 112 may be configured to fetch and store observed control signals, performance monitors, processor performance, and workload types. Memory fetch interface 112 may be configured to predict a set of memory data that needs to be fetched into the input buffers 120, and extracted from the output buffers 130. In at least some embodiments, the predicted set of memory data that needs to be fetched may correspond to data which may prove helpful for analyzing performance of the processing pipeline 150.

Training engine 114 is configured to receive the raw input data and identify one or more correlations between an internal state of a processor of processing pipeline 150, the performance of said processor, and a type of workload corresponding to said workload. In at least some embodiments, training engine 114 is trained to generate data/data address, instruction addresses, control signals, and prioritization decisions for the pipeline that maximize performance and energy efficiency. In at least some embodiments, training engine 114 is trained to identify a workload given a set of observed control signals, fetches, and performance metrics for the processor pipeline 150.

Control inference 116 may be configured to issue control signals that are optimized to provide the best performance for a given workload being executed. Based on the control signals, performance monitors, processor performance, and workload type, control inference 116 may be configured to infer data/data addresses and instruction addresses. In general, control inference 116 is the part of the AI governance engine 110 that is in charge of generating datapath control signals. The datapath control signals may include, but are not limited to, which instructions must be executed and in what order, which threads are to be prioritized, and arbitration policy decisions such as access to shared busses.

Input memory buffers 120 include one or more temporary storage areas configured to hold data received from an input device. In at least some embodiments, such as the embodiment depicted, input memory buffers 120 are configured to hold data received from AI governance engine 110. The data received from AI governance engine 110 and held by input memory buffers 120 may include signals for controlling a datapath of the processor pipeline. In at least some embodiments, input memory buffers 120 are configured to hold data/instructions that are being used or are ready to be moved to internal registry files.

Performance monitors 130 may be configured to monitor the performance of processing pipeline 150 and its various components. In at least some embodiments, performance monitors 130 monitor metrics such as, but not limited to, IPC, decoded and committed instructions, loads, etc. In at least some embodiments, performance monitors 130 store or provide metrics in sequences, and feed these sequences to a reconfigurable fabric that filters out which metrics are used in the training process. The reconfigurable fabric may be trained by training engine 114, thus automatically learning key metrics. In other embodiments, the reconfigurable fabric is configured by human expertise.

Output memory buffers 140 include one or more temporary storage areas configured to hold data created by processing pipeline 150. In at least some embodiments, such as the embodiment depicted, output memory buffers 140 are accessible by (or transmit data to) AI governance engine 110 via input memory buffers 120. The data held by output memory buffers 140 may include processor status information. In general, AI governance engine 110 may infer/predict a need for data stored in output memory buffers 140, and will issue a request that said data be made available via input memory buffers 120.

Processing pipeline 150 includes front end 151, queue 152, compute units 153, memory interface 154, and backend 155. Front end 151 is an interface between a user and the application processes of processing pipeline 150. In at least some embodiments, front end 151 enables a user to enter data that is collected and queued, via queue 152, to be processed by compute units 153. Compute units 153 may be configured to process received data in such away that it conforms to what the back end 155 can accept and process. Memory interface 154 may be configured to store data processed by compute units 153 until backend 155 is available to receive said stored data.

Sanity check unit 160 is configured to evaluate control signals emanated from AI governance engine 110 to ensure program correctness. In at least some embodiments, signals that sanity check unit 160 determines to be incompatible are defaulted to a safe state that will ensure program correctness at the expense of performance as necessary.

Control signals 170 are signals issued by AI governance engine 110 configured to control operation execution within processing pipeline 150. Control signals 170 may be configured to fetch right data and instructions at a right time, prioritize execution thread, prioritize instructions, or invalidate or write-back data.

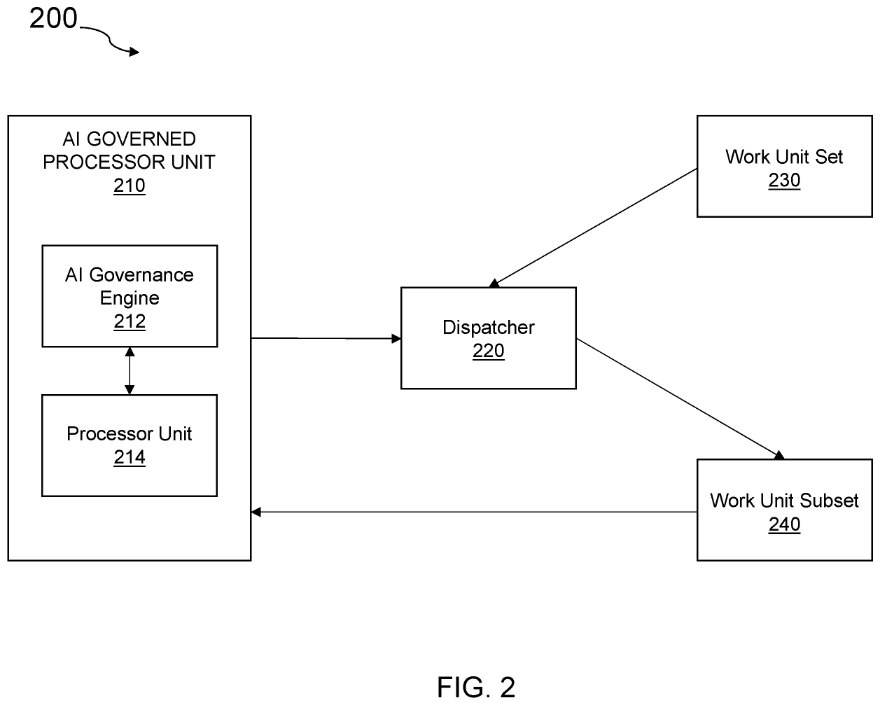

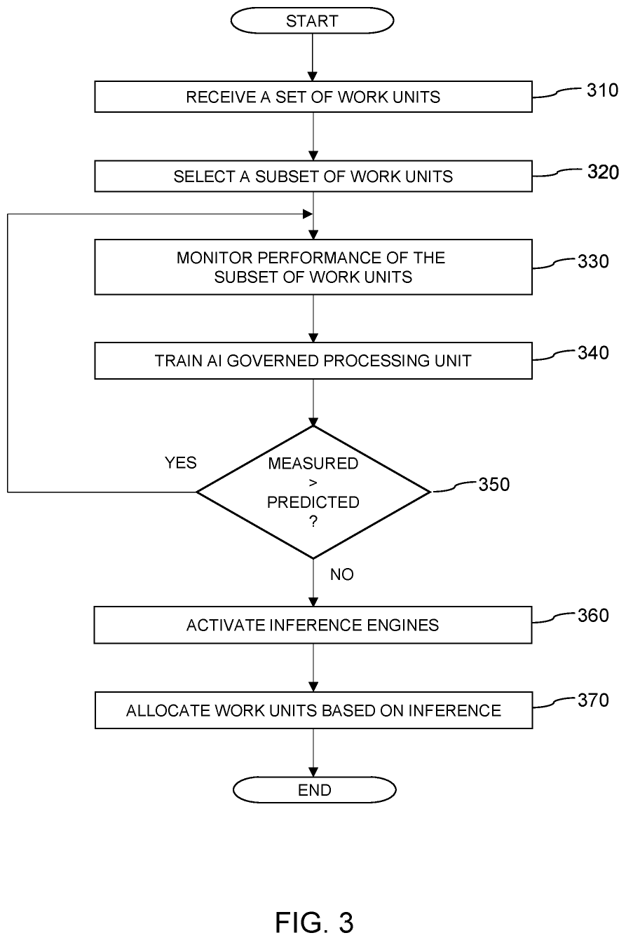

FIG. 2 is a dataflow diagram depicting a dispatching environment 200 in accordance with at least one embodiment of the present invention. As depicted, dispatching environment 200 includes AI governed processor unit 210, dispatcher 220, work unit pool 230, and work unit subset 240. As depicted, AI governed processing unit includes AI governance engine 212 and processor unit 214. It should be appreciated that processor unit 214 may not refer to a single processor, but rather to any arrangement of processors/processing units which are managed via the AIGP 210. The functions of the components of dispatching environment 200 are described with respect to dispatch method 300 in FIG. 3. Dispatching environment 200 may enable increased performance and efficiency relative to workload completion.

FIG. 3 is a flowchart depicting a dispatch method 300 in accordance with at least one embodiment of the present invention. As depicted, dispatch method 300 includes receiving (310) a set of work units, selecting (320) a subset of the set of work units, monitoring (330) the subset of work units for one or more epochs, training (340) an AI governed processing unit based on measured performance data from the monitored subset of work units, determining (350) whether the measured performance data exceeds predicted performance data, activating (360) the inference engines, and allocating (370) work units accordingly. Dispatch method 300 will be described with respect to dispatching environment 200 as depicted in FIG. 2. It should be appreciated that the term “work units” is used with respect to FIG. 3, and may be considered analogous to “tasks” or “sets of tasks” as referenced elsewhere.

Receiving (310) a set of work units includes a dispatcher, such as dispatcher 220, receiving a set of work units, such as work units 210, which it is responsible for managing. In at least some embodiments, receiving (310) a set of work units includes receiving authority to schedule the set of work units. Receiving (310) a set of work units may include receiving an indication that it is the responsibility of the dispatcher to allocate resources to complete said set of work units. In general, receiving (310) a set of work units includes receiving of a set of work units whose completion will be managed by a dispatcher 220.

Selecting (320) a subset of the set of work units may include identifying one or more work units of the set of work units which are to be scheduled to the AIGP 210. In at least some embodiments, selecting (320) a subset of the set of work units includes selecting work units which correspond to tasks as handled by the AIGP 210. For example, in a case where AIGP 210 is adept at handling certain operations based on its resource allocation, a subset of the set of work units may be chosen based on whether or not those work units correspond to said operations.

Monitoring (330) the subset of work units for one or more epochs may include monitoring the performance of the processor unit as it processes the subset of work units for a predetermined period of time. As described previously, the “epochs” for which the dispatcher may monitor the processor can correspond to a duration measured in units of time or in operational terms, such as the completion of a set number of operations, etc. In general, monitoring (330) the subset of work units for one or more epochs includes tracking the performance of the processor as it processes the subset of work units for the selected time period.

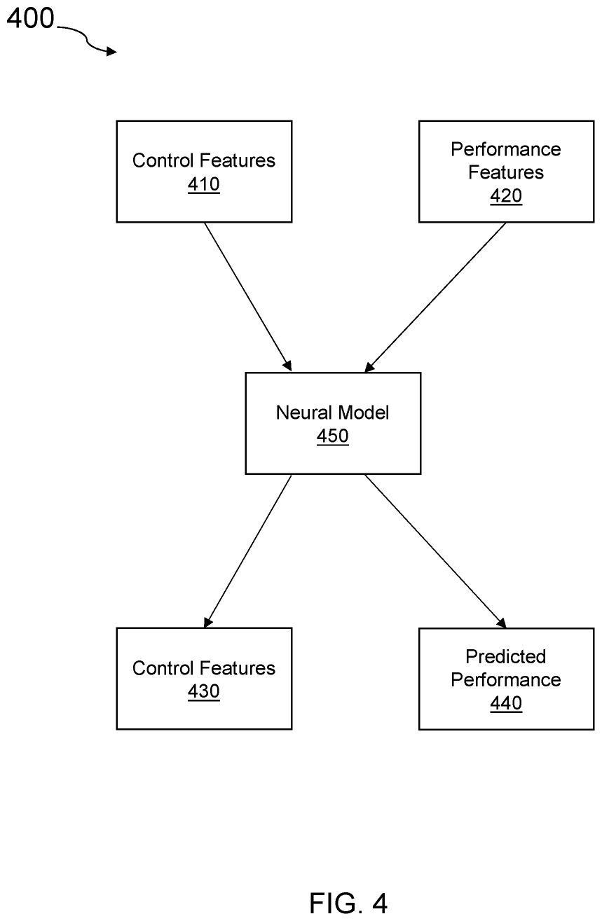

Training (340) an AI governed processing unit based on measured performance data from the monitored subset of work units may include feeding performance data to a neural model. An appropriate training methodology is described in greater detail with respect to FIG. 4.

Determining (350) whether the measured performance data exceeds predicted performance data may include comparing a calculated predicted performance metric to an observed measured performance metric. If the measured performance data exceeds the predicted performance data (350, yes branch), the method continues by returning to monitoring (330) the performance of the subset of work units for a selected number of additional epochs. In other words, if the measured performance is exceeding performance as predicted by AIGP 210, the method continues without activating the governance engine of AIGP 210. If the measured performance data does not exceed the predicted performance data (350, no branch), the method continues by activating (360) the inference engines.

Activating (360) the inference engines may include enabling the trained AI governance engine to determine an optimal resource utilization for the processor unit 214. In at least some embodiments, activating (360) the inference engines includes using the trained model of the AI governed processing unit to identify a most efficient utilization of the resources available via processor unit 214 relative to a current workload.

Allocating (370) work units accordingly may include allocating the subset of work units according to the optimal resource utilization as determined by the AI governed processing unit. In general, allocating (370) work units accordingly refers to allocating the work units to reflect the optimal allocation as determined by the AI governance engine. In general, the dispatcher can opt to allocate work units together or separately based on the optimal allocation, or can disable AI-governance for certain work units where it is either unnecessary or undesirable. Allocating (370) work units accordingly may additionally include receiving feedback reports from the AI governance engine indicating success of the AIGP's inferences and optimizations in terms of performance increase.

FIG. 4 is a functional block diagram depicting a training environment 400 in accordance with at least one embodiment of the present invention. As depicted, training environment 400 includes control features 410, performance features 420, control features 430, predicted performance 440, and neural model 450. Training environment 400 may enable a neural model of an AI governance engine to be trained based on control features and performance features of past epochs. The model may feed on a sequence and variety of inputs or features in both bit and float format. The features can be divided into two main types, control features 410 and performance features 420.

Control features 410 may include, but are not limited to, functional unit occupancy (bit), addresses (bit), and queue free and dispatched instructions (bit). Performance features 420 may include, but are not limited to, buffer hit rate (float) and IPC (float). Control features 410 and performance features 420 are concatenated and fed to neural model 450 within an AI governance engine. Neural model 450 may have different architectures (such as, but not limited to, deep neural networks (DNN), long short-term memory (LSTM), transformer, etc.), and can be a combination of several different approaches.

Output control features 430 correspond to control features as outputted from the neural model 450. Output control features 430 may include bit output such as data and instruction addresses to be fed to units in the AI governed processor. In at least some embodiments, output control features 430 include assignment of instructions to functional units. Output control features 430 may additionally include predicted data values. Output control features 430 may be checked by a sanity check unit. Predicted performance 440 as provided by the neural model 450 may include a predictor of performance for the following epoch.

In at least some embodiments, a switch may be implemented such that the AI governance engine may be switched off and on based on the comparison between the predicted performance and the measured performance. In other words, when the predicted performance exceeds the measured performance, the AI governance engine will either be turned on or will remain on; on the other hand, when the measured performance exceeds the predicted performance, the AI governance engine will either be turned off or will remain off.

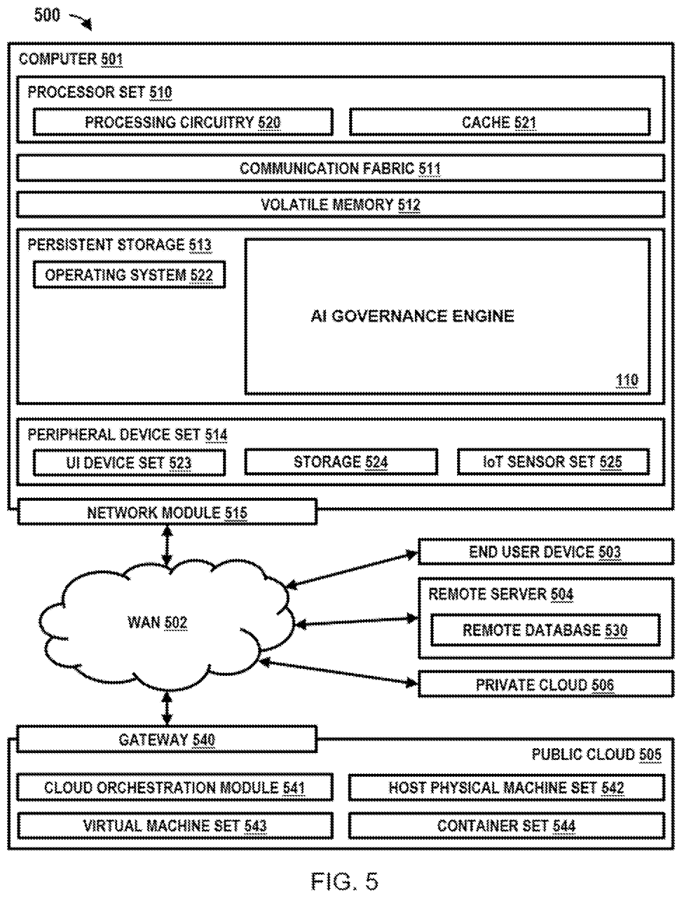

FIG. 5 is an example diagram of a distributed data processing environment in which aspects of one or more of the illustrative embodiments may be implemented, and at least some of the computer code involved in performing the inventive methods may be executed, in accordance with an embodiment of the present invention, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

Computing environment 500 contains an example of an environment for the execution of at least some of the computer code involved in performing the inventive methods, such as AI governance engine 110. In addition to AI governance engine 110, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and AI governance engine 110, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in AI governance engine 110 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in AI governance engine 110 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501) and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

While FIG. 5 depicts AI Governance Engine 110 in a first location, it should be appreciated that there are many embodiments of appropriate configurations for the AI governance engine 110. For example, the weights, biases, instructions, etc. may be housed in persistent storage in some embodiments, while the actual computational and inference mechanism may reside on or beside the processor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
identifying a set of tasks to be completed by an AI governed processing unit;
monitoring one or more performance metrics corresponding to performance of the AI governed processing unit while working on the set of tasks;
training an AI governance engine to predict performance metrics of the AI governed processing unit based on the monitored one or more performance metrics and one or more workload features corresponding to the identified set of tasks;
determining whether a first predicted performance metric according to the AI governance engine exceeds the monitored one or more performance metrics; and
responsive to determining the first predicted performance metric exceeds the monitored one or more performance metrics, enabling the AI governance engine to optimize workload allocation relative to the identified set of tasks and the AI governed processing unit.

2. The computer-implemented method of claim 1, wherein enabling the AI governance engine to optimize workload allocation comprises activating a setting corresponding to the AI governance engine such that said setting is in an “ON” position.

3. The computer-implemented method of claim 1, wherein enabling the AI governance engine to optimize workload allocation comprises allocating tasks separately to different units of the AI governed processing unit.

4. The computer-implemented method of claim 1, wherein enabling the AI governance engine to optimize workload allocation comprises enabling the AI governance engine for a subset of the set of tasks.

5. The computer-implemented method of claim 1, wherein enabling the AI governance engine to optimize workload allocation comprises denying the AI governance engine access to a specified subset of the set of tasks.

6. A computer program product comprising:
one or more computer readable storage media and program instructions collectively stored on the one or more computer readable storage media, the stored program instructions comprising program instructions to:
identify a set of tasks to be completed by an AI governed processing unit;
monitor one or more performance metrics corresponding to the performance of the AI governed processing unit while working on the set of tasks;
train an AI governance engine to predict performance metrics of the AI governed processing unit based on the monitored one or more performance metrics and one or more workload features corresponding to the identified set of tasks;
determine whether a first predicted performance metric according to the AI governance engine exceeds the monitored one or more performance metrics; and
responsive to determining the first predicted performance metric exceeds the monitored one or more performance metrics, enable the AI governance engine to optimize workload allocation relative to the identified set of tasks and the AI governed processing unit.

7. The computer program product of claim 6, wherein the program instructions to enable the AI governance engine to optimize workload allocation comprise instructions to activate a setting corresponding to the AI governance engine such that said setting is in an “ON” position.

8. The computer program product of claim 6, wherein the program instructions to enable the AI governance engine to optimize workload allocation comprise instructions to allocate tasks separately to different units of the AI governed processing unit.

9. The computer program product of claim 6, wherein the program instructions to the AI governance engine to optimize workload allocation comprise instructions to enable the AI governance engine for a subset of the set of tasks.

10. The computer program product of claim 6, wherein the program instructions to enable the AI governance engine to optimize workload allocation comprise instructions to deny the AI governance engine access to a specified subset of the set of tasks.

11. A computer system comprising:
one or more computer processors;
one or more computer readable storage media;
program instructions collectively stored on the one or more computer readable storage media for execution by at least one of the one or more computer processors, the stored program instructions comprising program instructions to:
identify a set of tasks to be completed by an AI governed processing unit;
monitor one or more performance metrics corresponding to the performance of the AI governed processing unit while working on the set of tasks;
train an AI governance engine to predict performance metrics of the AI governed processing unit based on the monitored one or more performance metrics and one or more workload features corresponding to the identified set of tasks;
determine whether a first predicted performance metric according to the AI governance engine exceeds the monitored one or more performance metrics; and
responsive to determining the first predicted performance metric exceeds the monitored one or more performance metrics, enable the AI governance engine to optimize workload allocation relative to the identified set of tasks and the AI governed processing unit.

12. The computer system of claim 11, wherein the program instructions to enable the AI governance engine to optimize workload allocation comprise instructions to activate a setting corresponding to the AI governance engine such that said setting is in an “ON” position.

13. The computer system of claim 11, wherein the program instructions to enable the AI governance engine to optimize workload allocation comprise instructions to allocate tasks separately to different units of the AI governed processing unit.

14. The computer system of claim 11, wherein the program instructions to the AI governance engine to optimize workload allocation comprise instructions to enable the AI governance engine for a subset of the set of tasks.

15. The computer system of claim 11, wherein the program instructions to enable the AI governance engine to optimize workload allocation comprise instructions to deny the AI governance engine access to a specified subset of the set of tasks.

16. A system comprising:
an artificial intelligence (AI) governance engine;
an AI governed processing pipeline configured to execute a set of one or more processing tasks; and
one or more performance monitors configured to monitor performance of the AI governed processing pipeline.

17. The system of claim 16, further comprising a sanity check unit configured to determine whether outputs of the AI governed processing pipeline adhere to one or more expected protocols.

18. The system of claim 16, further comprising a training module configured to:
process performance metrics as provided by the performance monitors; and
train the AI governance engine to infer performance outcomes based on the performance metrics as provided by the performance monitors and one or more features of the set of one or more processing tasks.

19. The system of claim 16, wherein the AI governance engine is configured to predict a set of memory data which will be helpful for analyzing performance of the AI governed processing pipeline.

20. The system of claim 19, further comprising one or more memory buffers configured to store the predicted set of memory data.

21. A method comprising:
receiving one or more performance metrics corresponding to an artificial intelligence governed processing pipeline;
training an artificial intelligence governance engine to predict performance outcomes based on performance metrics; and
determining an optimal resource allocation relative to a selected workload based on the trained AI governance engine.

22. The method of claim 21, further comprising determining whether the predicted performance outcomes of the AI governed processing pipeline adhere to one or more expected protocols.

23. The method of claim 21, further comprising:
processing performance metrics as provided by one or more performance monitors; and
training the AI governance engine to infer performance outcomes based on the performance metrics as provided by the performance monitors and one or more features of the selected workload.

24. The method of claim 21, wherein the AI governance engine is configured to predict a set of memory data which will be helpful for analyzing performance of the AI governed processing pipeline.

25. The method of claim 24, further comprising fetching and storing the predicted set of memory data.
